(19) United States
(12) Patent Application Publication
(10) Pub. No.: US 2004/0240957 A1
(43) Pub. Date: Dec. 2, 2004

(54) Load carrier

(76) Inventor: Robert Malcolm Ord, Gloucestershire (GB)

Correspondence Address: CAESAR, RIVISE, BERNSTEIN,, COHEN & POKOTILOW, LTD., 11TH FLOOR, SEVEN PENN CENTER, PHILADELPHIA, PA, 19103-2212, US

(21) Appl. No.: 10/487,601

(22) PCT Filed: Aug. 27, 2002
(86) PCT No.: PCT/GB02/03924

(30) Foreign Application Priority Data
Aug. 24, 2001 (GB) 0120644.0

(51) Int. Cl. B60P 1/64

(52) U.S. Cl. 410/90

(57) ABSTRACT

A load carrier such as a swap body for a road and/or rail vehicle including at least a base, the base being substantially square and defining a width and a length of the carrier, the base having at each of its corners a pair of spigot receiving locations, each one of the pair having a center, the distance between closest centers in a direction of the width and the length being a first distance and the distance between furthest centers in the direction of the width and length being a second distance.

This invention relates to a load carrier such as a swap body.

Swap bodies for the transport of goods are well known. They are of lighter construction than ISO containers and are mainly used on overland road and rail routes rather than deep sea traffic. They are commonly supplied in a minimum of 7.15 m lengths when used with drawbar road vehicles or a maximum of 13.6m long when used with road semi-trailers. They operate as a single unit with loading via one end door, sides or roof as required.

Location on transport units such as road vehicles or rail wagons is via ISO type lower corner castings in the swap body base frame and twist locks or spigots on the transport unit. Although swap bodies are usually wider than the original 8 ft. (2,438 mm) wide ISO containers, they still retain the standard. ISO transverse twistlock location centres of 2,259 mm. Longitudinal location centres are dependent on the length of the unit and the relevant ISO or swap body design standards.

Twist locks or spigots and the corresponding aperture in the load unit are approximately rectangular in shape: the longer axis being along the transport unit and the narrow axis being across the transport unit.

In Europe, because of restricted access at the terminals, rail wagons are fitted with spigots for swap body location. The spigot is shaped to prevent the overturning of the unit in gales. Road vehicles, because they are driver accompanied, are typically fitted with retractable twist locks.

Swap bodies are transferred fro rail or road transport units by means of expensive overhead equipment either as a top lift, the same as an ISO container, or as a bottom lift via a grappler system using pockets located on the swap body base frame.

A proposal for square based containers is known from EP 0483605 (Westerwalder). The base has a single spigot hole in a rotatable plate in each corner. If such a container were turned through 90° it would be necessary to adjust each plate which would be time consuming and could result in damage to the plates if they were misaligned. Also the handles protruding from the plates would be prone to be damaged.

According to the present invention, there is provided a load carrier comprising at least a base, the base being substantially square and defining a width and a length of the carrier, the base has at each of its corners a pair of spigot receiving locations each one of the pair having a centre, the distance between closest centres in a direction of the width and the length being a first distance and the distance between furthest centres in the direction of the width and length being a second distance. This provides a smaller than existing standard swap body whose width and length are the same and correspond to the maximum road vehicle width. The base preferably comprising a base frame with fork lift pockets on all four sides and corner castings or aperture plates containing two apertures per corner each aperture being centred on the centres of the locations Preferably the first distance is 2000 mm and the second distance is 2,259 mm and between 2,245 mm and 2,275 mm. The body preferably has two opposing members which may be solid extending from the base to a roof. The two remaining sides may each be provided with closure: or only one closure is provided. Such a swap body provides complete four way loading capacity with solid sides or closures to end or side. Location on road or rail vehicles is preferably by twistlocks or spigots at conventional notation and transverse centres.

According to another aspect of the invention, there is provided a road or rail vehicle having spigots in sets of four spigots, each set arranged to receive the carrier of the first aspect of the invention the transverse and longitudinal distance apart of the spigots of each set corresponding to the said second distance and the said first distance of the said carrier.

An embodiment of the invention will now be described by way of example with reference to the accompanying drawings in which:—

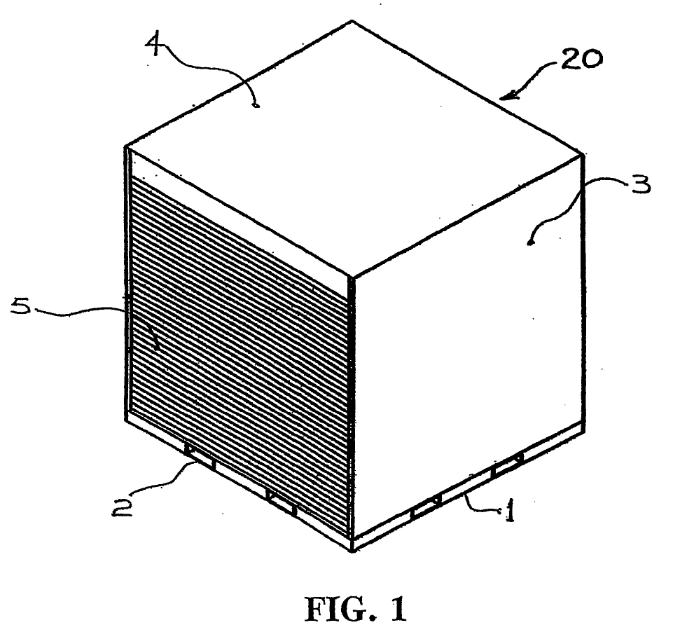

FIG. 1. shows in perspective, a carrier according to the invention being a swap body;

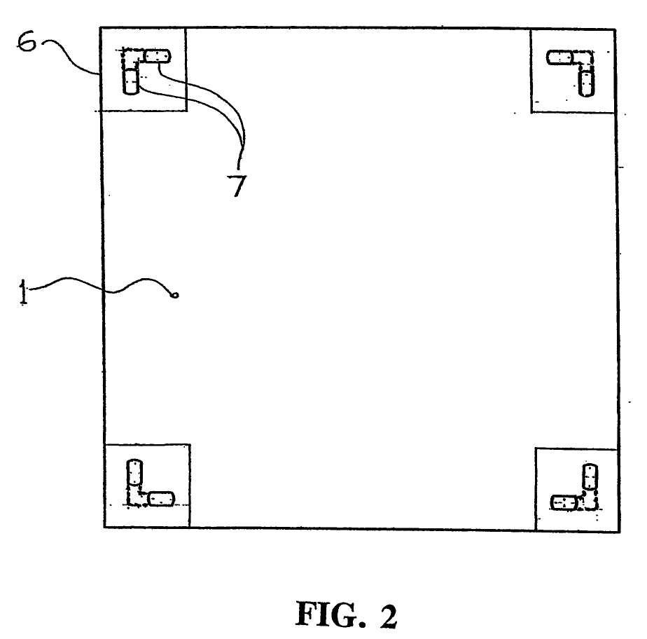

FIG. 2 shows underside view of the swap body of FIG. 1;

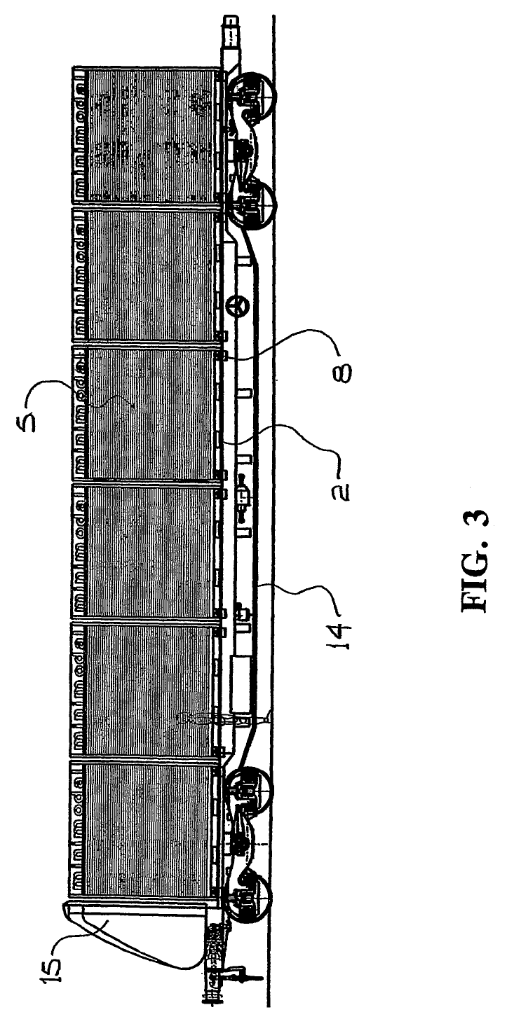

FIG. 3 shows six of the swap bodies of FIG. 1 mounted on rail wagon;.

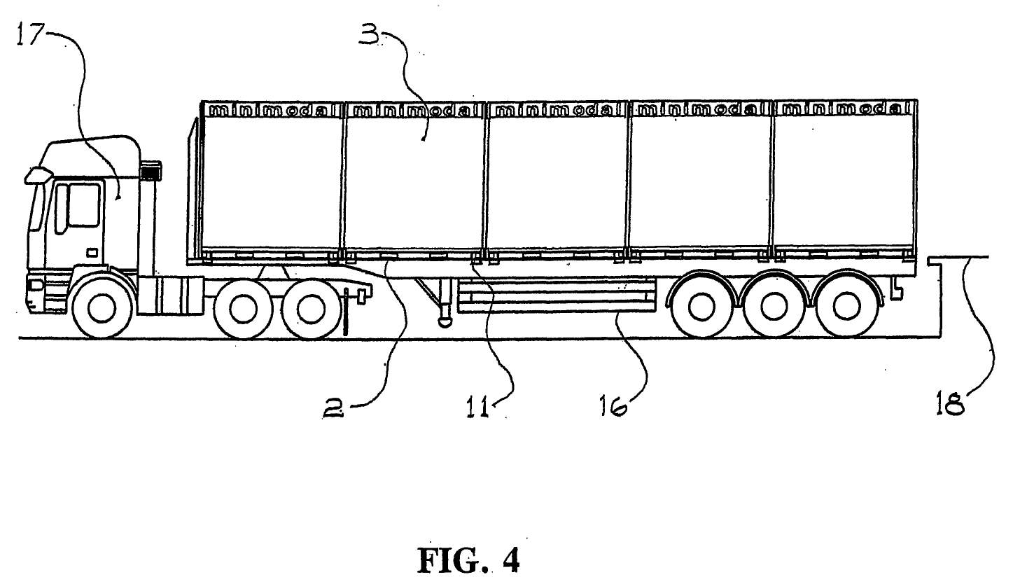

FIG. 4 shows five swap bodies of FIG. 1 mounted on road vehicle; and

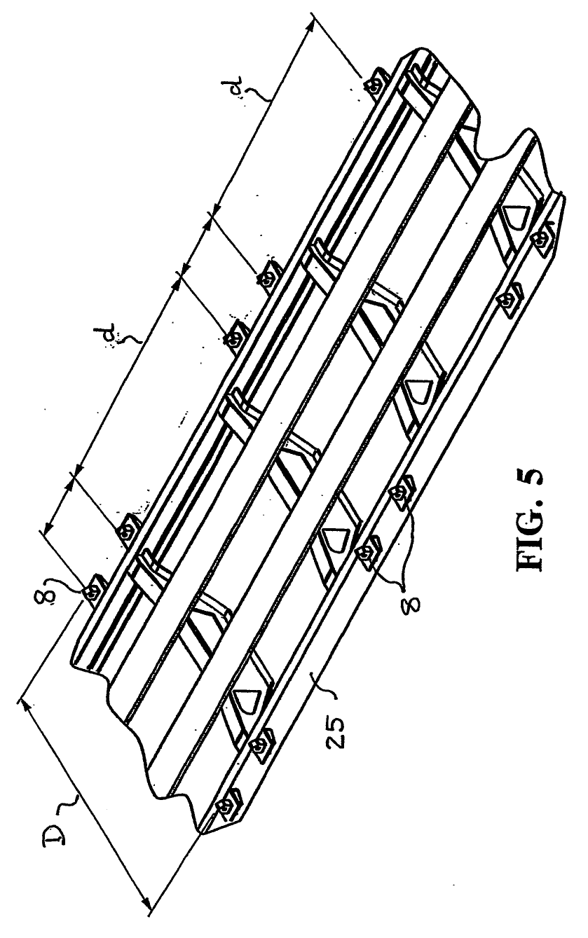

FIG. 5 shows in perspective a frame of the rail wagon of FIG. 3.

Referring to the drawings: the swap body 20 comprises a small load unit square in plan view with fork lift pockets 2 for transfer between road, and rail vehicles. Twistlock aperture plates 6 in the four bottom corners 22 of the swap body allow it to be positioned in any one of four positions; that is one side facing forwards to one side or backwards. Closures 5 on opposing sides provide the option to have security or access on a transport vehicle by facing the closures to the front/rear or side of the transport vehicle.

FIG. 1 illustrates the swap body 20 with square. base frame 1, fork lift pockets 2 (on all four sides), solid side members 3 (on opposite sides), roof 4 and closure 5 (including opposing side). Units used for chilled distribution could be designed with only one closure. The closure may be a door or doors or a shutter or even a curtain. For certain goods the swap body may only comprise a base frame 1 with the fork lift pockets 2 The solid side members may be wholly or partly grilled.

FIG. 2 illustrates an underside view of one swap body with square base frame 1, four twistlock aperture plates 6 and location slots 7 having centres 13. The slots 7 are positioned so that the distance (d) between the closest centres is 2,259 mm. Apart. That remains true as the base is rotated so that when the swap body is fitted to the vehicle frame spigots 8 there will always be four spigots engaging with four apertures 7 in the base frame. Whilst the pairs of apertures 7 as at each corner are shown as separate, a single “L” shaped aperture could be provided. This is shown in broken lines in FIG. 2 as extending between the longitudinal sides of the aperture pairs.

FIG. 3 illustrates a rail wagon 14, transporting six swap bodies, showing fork lift truck pockets 2, closure 5 and spigots (on wagon) 8. The swap bodies are shown with closures to side (for access)—they could be loaded with closures to end for security, including loading against a wagon bulkhead 15. The wagon 14 is illustrated as one part of a twin set—the wagon could be a single unit—articulated or two axle type.

FIG. 4 illustrates a road semi-trailer 16, tractor unit 17, transporting five swap bodies showing fork lift pockets 2, solid side 3 and twist locks (on trailer) 11. The swap bodies are shown with closures to end which can be used for end through loading from swap to swap including roll cages from loading dock 18. The swap bodies can also be used with closures to the side for side access. Rigid body road vehicles can be used carrying any number of swap bodies. Individual swap bodies can be removed or added as required.

FIG. 5 shows a frame 25 for the rail wagon 14 showing more clearly the location of the spigots 8 and the distance D common to the transverse distance between spigots of a set of four spigots for each swap body. The distance d is common to the longitudinal distance apart of the spigots.

The example illustrates a swap body with conventional body construction. Insulated construction for chilled distribution could be used. Current regulations allow a maximum road width of 2,600 mm.

The example illustrates a swap body with two opposing side closures and a solid roof. Any variation of closures and solid panels could be used. Two closures on opposite sides may be provided. Generally, however, only one closure needs to be provided. This has the advantage that closure when on a vehicle can face towards or backwards to prevent access from the sides of the vehicle.

The example illustrates a swap body with roller shutter doors. Other types of closures, for example conventional doors or curtains, could be used.

The example illustrates a swap body with only lower mounting locations. The swap body units could be provided with top lift fixtures. The swap bodies could also be stackable on the ground.

1. A load carrier comprising at least a base, the base being substantially square and defining a width and a length of the carrier, wherein the base has at each of its corners a pair of spigot receiving locations, each of the locations having a center, wherein a minimum spacing between centers both widthwise and lengthwise is a first distance (d) and a maximum spacing between centers both widthwise and lengthwise is a second distance (D), the spigot receiving locations being arranged such that the load carrier can be affixed to spigots provided on a corresponding vehicle frame in any of four mutually orthogonal orientations without any adjustment to a position or an orientation of the spigots.

2. The load carrier of claim 1 wherein the base has a frame defining fork lift pocket on all four sides.

3. The load carrier of claim 1 wherein each corner of the base comprises a casting or plate having pair of elongate apertures by way of spigot receiving locations wherein elongate axes of the apertures of each pair are substantially at right angles to one another.

4. (Cancelled).

5. The load carrier of claims 1 wherein two opposing side members extend upwardly from the base to a roof.

6. The load carrier of claim 5 wherein at least one of the remaining sides of the carrier has a closure.

7. The load carrier of claim 6 wherein the closure is formed as on or more doors or shutters.

8. The load carrier of claim 1 wherein the first distance (d) is approximately 2,000 mm.

9. The load carrier of claim 1 wherein the second distance (D) is between about 2,245 mm and about 2,3275 mm.

10. (Cancelled).

11. The load carrier of claim 9 wherein the second distance (D) is approximately 2259 mm.

12. A load carrier comprising at least a base, the base being substantially square and defining a width and a length of the carrier, wherein the base has at each of its corners a pair of spigot receiving locations, which spigot receiving locations are symmetrically oriented with respect to axes of symmetry of the base such that the load carrier can be affixed to spigots provided on a corresponding vehicle frame in any of four mutually orthogonal orientations without any adjustment to a position or an orientation of the spigots.

13. The load carrier according to claim 12, wherein said spigot receiving locations comprise two elongate spigot receiving slots which are respectively disposed parallel to the length and to the width of said carrier.

14. The load carrier according to claim 13, wherein said elongate spigot receiving slots at each spigot receiving location form a single “L” shaped aperture.

15. A frame for a road or rail vehicle, which frame comprises at least one set of spigots, characterized in that each set of spigots is arranged to engage spigot receiving locations of the load carrier of claim 1, so as to enable the carrier to be held by the spigots in any of four mutually orthogonal orientations relative to a vehicle bearing the frame.

16. A road or rail vehicle comprising at least one set of spigots, characterized in that each set of spigots is arranged to engage spigot receiving locations of the carrier of claim 1, so as to enable the carrier to be held by the spigots in any of four mutually orthogonal orientations relative to said vehicle.
